(19) United States
(12) Patent Application Publication
(10) Pub. No.: US 2010/0187340 A1
(43) Pub. Date: Jul. 29, 2010

(54) DRYING AND MILLING APPARATUS AND PROCESSING PLANT

(75) Inventor: Patrick Potter, Hamilton (NZ)

Correspondence Address: BROOKS KUSHMAN P.C., 1000 TOWN CENTER, TWENTY-SECOND FLOOR, SOUTHFIELD, MI, 48075, US

(73) Assignee: ENVIRO ENERGY LIMITED, Hamilton (NZ)

(21) Appl. No.: 12/677,644

(22) PCT Filed: Sep. 12, 2008
(86) PCT No.: PCT/NZ08/00234

§ 371 Date: Mar. 11, 2010

(30) Foreign Application Priority Data
Sep. 13, 2007 (NZ) 561417
Jan. 22, 2008 (NZ) 565288

(51) Int. Cl. B02C 21/00; C02F 11/12; B02C 19/00; B02C 23/08; F26B 7/00

(52) U.S. Cl. 241/18; 210/251; 241/38; 241/278.1; 241/68; 34/387

(57) ABSTRACT

A drying and milling apparatus includes a housing and a rotatable section. The housing has an air or gas inlet and a product inlet at a first end and a product outlet at a second end. The rotatable section has a plurality of blades which extend radially from a hub portion of the rotatable section and are adapted to rotate within the housing and to break up and to mill any product that is introduced into the housing. The product inlet is configured to direct any incoming product directly onto the blades of the rotatable section. Also included is a sewerage processing plant incorporating at least one drying and milling apparatus substantially as specified herein, a method of drying and milling substantially dewatered sewage and a sewage treatment process incorporating a method of drying and milling substantially dewatered sewage substantially as herein described.

### FIELD OF THE INVENTION

This invention relates to a drying and milling apparatus and method and a processing plant and process, and in particular, but not exclusively to a drying apparatus and method and a processing plant and process for use in the drying, milling and/or the processing of sewage.

### BACKGROUND

The sewage in sewerage treatment plants contains large quantities of water and to be effectively dealt with it is usually necessary to separate the solids from the water at some stage during the treatment process.

De-watering devices, for example belt presses work reasonably effectively but typically they are only able to reduce the water content of sewage sludge to about 80 percent water and 20 percent sewage solids. It is a feature of sewage that it is very difficult to separate the solids entirely from the water since the water is highly entrained in the sewage solids.

While this level of water separation may be suitable for some applications, for example, for the de-watering of sewage sludge for land-fill disposal, it is not sufficient for other applications. In sewerage treatment plants where the sewage solids are to be used as a source of energy, for example by burning dried sewage, it is necessary to further reduce the water content.

Further drying of the sewage could be carried out in a number of ways, for example by sun drying, however in a large sewerage treatment plant the quantities of sewage would make such a method impractical. It is also important that any moist air that is removed from the sewage solids during any drying process is contained, so that it can be treated prior to disposal. This is because the moist air that is produced during such a drying process usually contains offensive odours and possibly other contaminants.

For efficient combustion of sewage it is not only necessary to dry it, but also to mill it into fine particles. Better efficiencies are often achieved by burning fuels in suspension and very small particle sizes are required for such a combustion method. The nature of damp or dewatered sewage is such that it tends to bind readily. De-watered sewage has been found to be very sticky and tends to bind into clumps or balls and these clumps are difficult to process in previously devised milling or drying equipment. The inventor of the present invention has been involved in the milling and drying of various products, including sewage for some time. The problem of the sewage binding up, or balling, within previously devised milling and drying equipment has lead to need to develop of the present invention.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a drying and milling apparatus and method and a processing plant and process, drying apparatus which will at least go some way towards overcoming the above mentioned problems, or at least provide the public with a useful choice.

### STATEMENTS OF THE INVENTION

Accordingly, in a first aspect, the invention consists in a drying and milling apparatus having a housing and a rotatable section, the housing having an air or gas inlet and a product inlet at a first end and having a product outlet at a second end, the rotatable section having a plurality of blades which extend radially from a hub portion of the rotatable section and being adapted to rotate within the housing and to break up and to mill any product that is introduced into the housing, and the product inlet being configured to direct any incoming product directly onto the blades of the rotatable section.

Preferably the product inlet is configured to direct any incoming product directly onto the tips of the blades.

Preferably the rotatable section includes a first stage which is adapted to slice, chop or macerate any incoming product and a second stage which is adapted to finely mill the sliced, chopped or macerated product.

Preferably the apparatus further includes stationary blades or vanes which project inwards generally from an outer diameter of the housing and which are situated between the paths of any rotating blades or vanes of the rotatable section.

Preferably at least a portion of the blades of the first stage of the rotatable section are configured such that a width of each blade is generally aligned with the direction of rotation of the rotatable section.

Preferably at least a portion of the blades of the second stage of the rotatable section are configured such that a width of each blade is generally aligned with the rotational axis of the rotatable section.

Preferably the blades of the rotatable section are fixed relative to the hub portion of the rotatable section.

Preferably the air or gas inlet is configured to introduce air or gas towards a first end of the rotatable section.

Preferably the product outlet is situated adjacent to or about the rotational axis of the rotatable section.

Preferably at least a portion of the housing is cylindrical in shape and the tips of the blades of the rotatable section are configured to travel adjacent to an internal diameter of the cylindrical shaped portion.

Preferably at least a portion of the surface of the internal diameter of the housing is provided with grooves.

Preferably the grooves are substantially helically aligned with respect to the rotational axis of the rotatable section.

Preferably the second stage of the rotatable section in conjunction with the surface of the internal diameter of the housing forms an attrition mill.

Optionally the apparatus can further include a classifier configured to inhibit the progress of larger damper particles of product toward the product outlet

Preferably the classifier includes a centrifugal separator.

In a second aspect, the invention consists in a sewerage processing plant incorporating at least one drying and milling apparatus substantially as specified herein.

Preferably the plant further includes sewage sludge de-watering apparatus which is able to at least partially de-water sewage prior to the sewage entering the drying and milling apparatus.

In a third aspect, the invention consists in a method of drying and milling substantially dewatered sewage including the steps of;
introducing the dewatered sewage into a chamber
slicing or chopping the dewatered sewage within the chamber,
introducing heated air into the chamber and exposing the sliced or chopped sewage to the heated air immediately as it is sliced or chopped,
passing the sliced or chopped sewage directly into an attrition mill located within the same chamber, and
allowing the finer or drier milled particles of the product to exit the chamber along with the airflow that is induced through the chamber.

Preferably the airflow rate through the chamber is adjustable to allow a desired particle size or particle moisture content to be achieved.

Preferably the rotational velocity of the mill is adjustable to allow a desired particle size or particle moisture content to be achieved.

Preferably the average size of the particles that exit the chamber is less than 1.5 millimetres in diameter.

More preferably the average size of the particles that exit the chamber is less than 0.5 millimetres in diameter.

And yet more preferably at least 80 percent of the particles that exit the chamber are less than 0.08 millimetres in diameter.

Preferably the moisture content of the particles that exit the chamber is less than twenty percent by mass.

More preferably the moisture content of the particles that exit the chamber is less than fifteen percent by mass.

And yet more preferably the moisture content of the particles that exit the chamber is between five and twelve percent by mass.

In a fourth aspect, the invention consists in a sewage treatment process incorporating a method of drying and milling substantially dewatered sewage substantially as herein described.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be limiting.

### DESCRIPTION

Further aspects of the present invention will become apparent from the following description which is given by way of example only and with reference to the accompanying drawings in which:

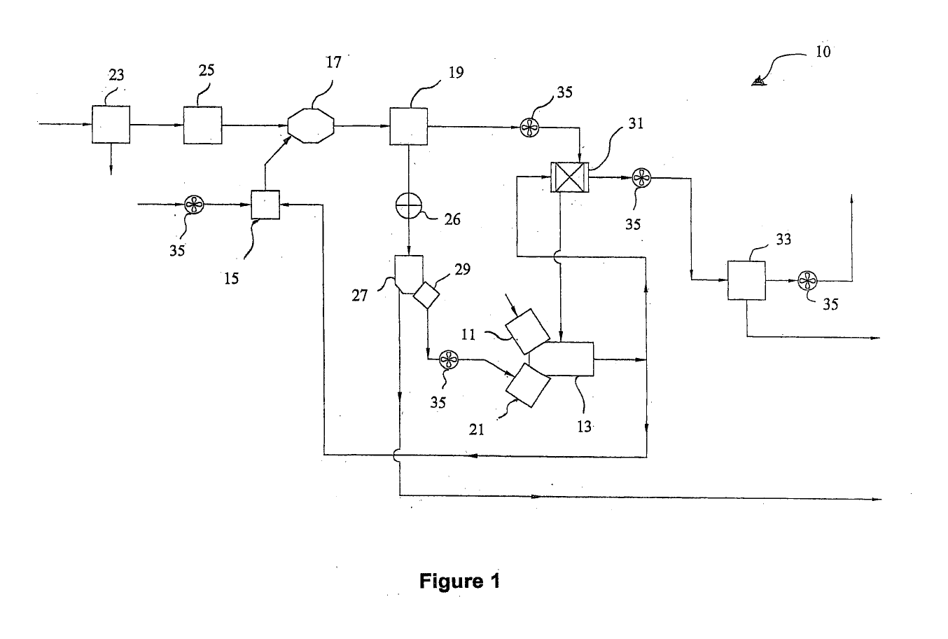

FIG. 1 is a schematic view of a sewerage processing plant,

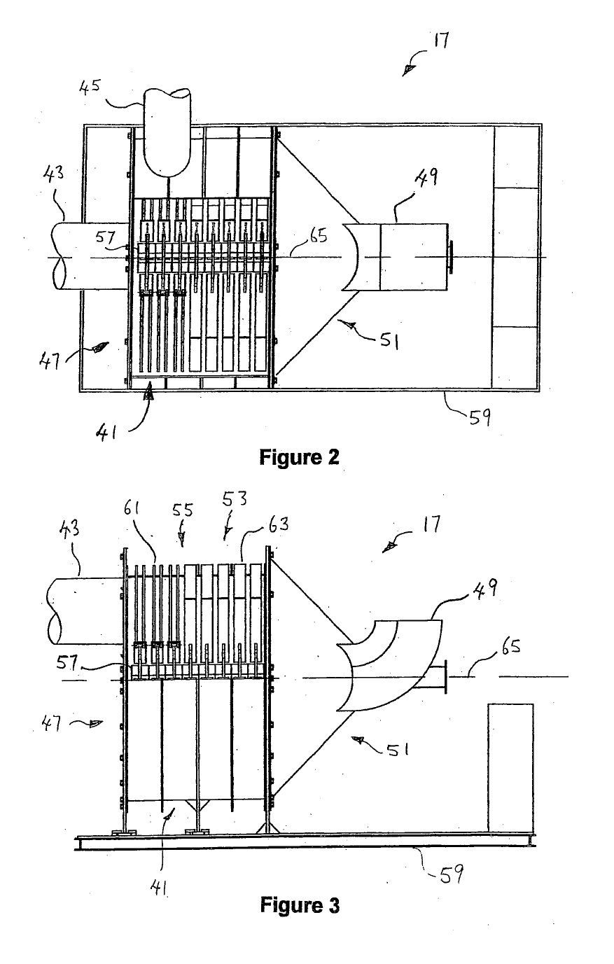

FIG. 2 is a top plan view of a drying and milling apparatus of the processing plant, the apparatus being shown with part of a housing removed to show the internal parts of the apparatus,

FIG. 3 is a side elevation view of the drying and milling apparatus, again with part of the housing removed, and

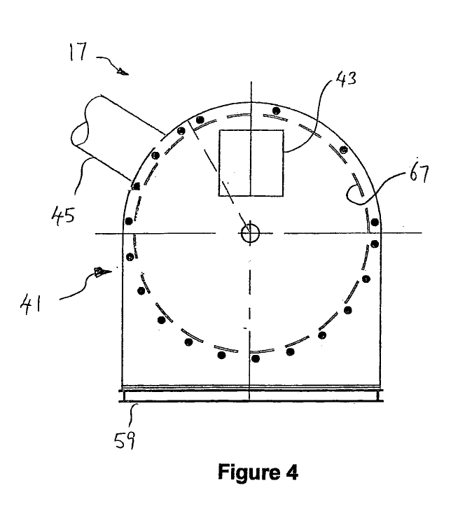

FIG. 4 is an end view of the apparatus.

With reference to FIG. 1, a plant (10) for the processing of sewage is shown in a schematic form. The plant (10) and the method of operation of the plant is described as follows.

The process begins by initially producing a flow of heated air for use in the plant (10). This heated air flow can be produced by burning a supplementary fuel using a first burner (11) which is situated within a sterilisation chamber (13), or alternatively by burning a supply of previously dried sewage. At least a portion of the hot exhaust gases produced in the sterilisation chamber (13) are supplied to a mixer (15) to be mixed with a supply of fresh air to produce heated air at a desired temperature for use in a drying and milling apparatus (17).

This heated air is preferably at a temperature within the range of 500 to 700 degrees C. and is supplied to the sewage drying and milling apparatus (17). Ideally the temperature of this heated air is between 580 and 620 degrees C. The drying and milling apparatus (17) is used to dry the sewage and to mill it, to produce dried sewage in a powdered form.

Sewage sludge must be de-watered to some extent prior to entering the drying and milling apparatus (17), for example using a belt press. The plant (10) can further include a sewage sludge de-watering apparatus. Dewatered sewage from a belt press can be rather lumpy and it may be necessary to vibrate it or stir, chop or auger it to break down the lumps so that a steady flow is introduced into the drying and milling apparatus (17). It is important to introduce the sewage into the drying and milling apparatus (17) in a controlled manner so that the operating temperatures within the drying and milling apparatus (17) can be maintained within desired tolerances.

An uneven flow rate of sewage entering the drying and milling apparatus (17) can cause temperature fluctuations both inside the drying and milling apparatus (17) and in the airflow that exits the drying and milling apparatus (17). The temperature can fluctuate because of a change in the mass flow rate of the sewage, or because of changes in efficiency within the drying and milling apparatus (17) caused by clogging or other factors. Fluctuations in the temperature of the air that exits the drying and milling apparatus (17) can adversely affect a downstream separator system, particularly a bag type separator.

Preferably the drying and milling apparatus (17) includes rotating blades, or the like, to break up the incoming sewage to expose it to the incoming heated air. The efficiency of the process or plant depends to some extent on the particle size of the dried sewage that is produced by the drying and milling apparatus (17). This is because, like many solid fuels, the sewage will burn more efficiently if it is burned in suspension. Solid fuels that are burned in suspension as fine particles tend to burn more rapidly, releasing energy at a higher rate, and often less ash is produced.

The moisture content of the dried sewage particles should be less than 20 percent by mass, and preferably less than 15 percent. For optimum efficiency of the process the moisture content of the dried sewage particles should ideally be between 5 and 12 percent by mass.

The dried sewage, and the now moisture laden air, from the drying and milling apparatus (17) are passed through a first separator (19) to be separated. The first separator (19) can take many forms for example a bag filter, a cyclonic separator or a grit arrestor.

At least a portion of the dried sewage is passed to a second burner (21) of the sterilisation chamber (13) to be burned. The sterilisation chamber (13) could also be called a combustion chamber or an incinerator since part of the dried sewage is burned in the sterilisation chamber (13), however its main purpose is to sterilise or deodorise the air that is used to dry the sewage.

Preferably the dried sewage is burned in suspension in the sterilisation chamber (13). It is by burning the dried sewage in suspension that allow the significant efficiencies of the process to be realised. And to enable the dried sewage to be burned in suspension the particle size of the dried sewage should be very small, that is at least less than 0.5 millimetres (mm) in diameter. It is even better if the particles are less than 0.2 millimetres (mm) in diameter, and for optimum efficiency at least 80 percent of the particles should be less than 0.08 mm in diameter.

Burning in suspension allows a much greater rate of heat release from the combustion of the dried sewage. By comparison, when burning a product using a grate method it is typical for only about 70% of the product to be burned, yet when burning a product in suspension it is common to burn approximately 80% or more of the product. This means that when the sewage is burned in suspension the ash that is produced will contain less carbon and have a lower volume. And, it is common for the emissions from the combustion process to be less harmful when the burning is carried out in suspension. In addition, when burning in suspension it can be easier to control combustion temperatures as this can be controlled more directly by varying the airflows used in the combustion process. Also, burning in suspension can significantly reduce or eliminate the production of clinker which can be detrimental to a combustion chamber.

Once the dried sewage begins to burn, the first burner (11) can be turned down or be completely turned off. This eliminates or reduces the need for the use of the supplementary fuel which in most cases is intended only to get the process started. A portion of the hot exhaust gases from the sterilisation chamber (13) continues to be drawn off to be supplied to the mixer (15) to produce the heated air for the drying and milling apparatus (17).

The moisture laden air is also supplied to the sterilisation chamber (13) to be heated by the combustion occurring within the sterilisation chamber (13). Heating this moisture laden air to approximately 760 to 870 degrees C., or ideally to between 800 and 850 degrees C., for a period of approximately 0.4 to 1.3 seconds can sterilise and/or deodorise this air to some extent. Since the moisture laden air has been used to dry the sewage it is not suitable for release directly to the atmosphere without being deodorised and/or purified at least to some extent. While experts differ as to the ideal temperature to hold the gases at, and the required time period, it is presently considered by the inventors that the optimum temperature range is between 800 and 850 degrees Celsius (C) and the optimum time period is between 0.5 and 1.0 seconds.

It has been calculated that most sewage contains more than enough energy to elevate the temperature of the moisture laden air to 760 to 870 degrees C. In fact it is anticipated that a useful quantity of excess dried sewage can be extracted from this process for other purposes, for example, for electrical power generation. And since the supplemental fuel supply is only required during start-up, the process can quite easily produce a net energy output.

Sewage from a sewerage treatment plant is typically in a sludge form and the process can include an initial dewatering step as noted above. The dewatering can be carried out using a belt dryer (23) and if desired a stockpile of dewatered sewage can be stored in a suitable hopper (25) ready for introduction into the process (10). Alternative dewatering devices could be used for this purpose, for example a centrifugal separator.

Dried sewage which has been separated out by the first separator (19) can be passed via a rotary valve (26) to be stored in a dried sewage storage bin (27) prior to some of it being passed to the second burner (21). Since the dried sewage is ideally in a powdered form it can be extracted from the bin using an auger (29) and be transported to the second burner (21) in a fluidised state within a flow of air. If the process is running efficiently, not all of the dried sewage is required for use in the sterilisation chamber (13) and a useful percentage can be extracted from the system for use as an energy source.

As noted above, a portion of the hot exhaust gases produced in the sterilisation chamber (13) are used to produce hot air to dry the sewage. The remainder of the exhaust gases can be released to the atmosphere, however, prior to release to the atmosphere, heat from these exhaust gases can be extracted via a heat exchanger (31) to heat the moisture laden air prior to the moisture laden air being supplied to the sterilisation chamber (13). This assists in ensuring that the, moisture laden air reaches the desired temperature within the sterilisation chamber (13) to meet any required deodorising and/or purification requirements, and it helps to minimise the fuel requirements to keep the sterilisation chamber (13) at the required temperature.

The exhaust gases can also be passed through a second separator (33) to remove any ash present in the gases. Both the first and the second separators, (19) and (33), can use bag type filter elements. Commercially available bag filter elements, that are not excessively expensive, are rated to approximately 200 degrees C.

Preferably the moisture laden air leaves the drying and milling apparatus at approximately 100 to 140 degrees C., as the first separator (19) is able to cope with these temperatures. As this moisture laden air passes through the heat exchanger (31) the aim is to raise its temperature to approximately 420 to 530 degrees C., or ideally to between 450 and 500 degrees C. Similarly, it is preferable that the hot exhaust gases which pass through the heat exchanger (31) have their temperature reduced from the 800 degrees C. that they reach in the sterilisation chamber (13) to approximately 150 to 120 degrees C. before they pass through the second separator (33).

The schematic diagram shows a number of fans (35) which can be used to assist the movement of air and gases about through the process. While five fans are shown it is envisaged that not all of these may be necessary, or more may be required. The requirement for fans will depend on the actual configuration of a plant which is produced to carry out the process described herein.

With reference to FIGS. 2 to 4, the drying and milling apparatus (17) is shown and described in greater detail. The drying and milling apparatus (17) includes a housing (41) which defines a chamber in which the drying and milling takes place. The housing has an air or gas inlet (43) and a product inlet (45) at a first end (47) and has a product outlet (49) at a second end (51). The drying and milling apparatus (17) is designed at least primarily to mill and dry a product in the form of damp or dewatered sewage.

The drying and milling apparatus (17) also includes a rotatable section (53), which has a plurality of blades (55) which extend radially from a hub portion (57) of the rotatable section (53). The rotatable section (53) is adapted to rotate within the housing (41) and to break up and to mill any product that is introduced into the housing (41). Both the housing (41) and the rotatable section (53) can be supported by a main frame (59), and the rotatable section (53) can be supported on a shaft (not shown) and can be driven by a motor, for example an electric motor (not shown).

The rotatable section (53) includes a first stage (61) which is adapted to slice, chop or macerate any incoming product and a second stage (63) which is adapted to finely mill the sliced, chopped or macerated product. The product inlet (45) is configured to direct any incoming product directly onto the tips of the blades (55) of the first stage (61) of the rotatable section (53).

The apparatus (17) further includes stationary blades or vanes (not shown) which project inwards generally from an outer diameter of the housing (41) and which are situated between the paths of any rotating blades or vanes (55) of the rotatable section (53).

At least a portion of the blades of the first stage (61) are configured such that a width of each blade is generally aligned with the direction of rotation of the rotatable section. Due to this configuration the blades of the first stage (61) are able to chop or slice the incoming product.

At least a portion of the blades or circulators (55) of the second stage (63) are configured such that a width of each blade is generally aligned with the rotational axis (65) of the rotatable section (53). Due to this configuration the blades or circulators (55) of the second stage (63) are able to circulate the chopped or sliced product and to mill it.

In this example the blades (55) of the rotatable section (53) are fixed relative to the hub portion (57) of the rotatable section. An advantage of this configuration is that the blades cannot simple pivot away to allow a clumping or balling of sewage which has a tendency to want to reconstitute itself into larger balls or clumps.

At least a portion of the housing (41) is cylindrical in shape and the tips of the blades (55) of the rotatable section (53) are configured to travel adjacent to an internal diameter (67) of the cylindrical shaped portion. Preferably at least a portion of the surface of the internal diameter (67) of the housing (41) is provided with grooves (not shown). And preferably the grooves are substantially helically aligned with respect to the rotational axis (65) of the rotatable section (53).

Preferably the substantially helically aligned grooves on the internal diameter (67) are aligned to some extent with the swirling flow of the air and product as it moves through the apparatus (17) and is rotated by the rotatable section (53). Such an alignment can help to dislodge trapped product from the grooves and keep them substantially clean.

The second stage (63) of the rotatable section (53) in conjunction with the surface of the internal diameter (67) of the housing (41) forms an attrition mill. The product can be caused to rub against itself by the action of the blades (55) of the second stage (63) as it pushes some of the product past other product that is at least partially held by the grooves in the internal diameter (67) of the housing (41). In use, the tip velocity of the blades (55) is preferably within the range of 25 to 35 metres per second.

It can be seen in the figures that the air or gas inlet (43) is configured to introduce air or gas towards the first end (47) of the rotatable section (53), and the product outlet (45) is situated towards the second end (51) of the rotatable section (53) and is adjacent to or about the rotational axis (65) of the rotatable section (53). This allows an airflow through the apparatus (17) to be created. Only the drier and lighter particles of product will tend to leave the apparatus via the product outlet (45) since a centrifugal action within the housing (41) will tend to hold the heavier damper particles within the milling zone, that is, near the surface of the internal diameter (67) of the housing (41).

The level to which the product is dried and milled can to some extent be adjusted by varying the airflow through the apparatus (17), and therefore the average flow velocity, and by adjusting the rotational velocity of the blades (55) of the rotatable section (53). With higher airflow rates and lower rotational velocities, heavier, or larger and damper particles can find their way to the product outlet, but lower airflow velocities, and higher rotational velocities will tend to hold these particles inside the housing (41) for longer.

As the sewage is broken up and milled within the apparatus (17) the surface area of the sewage is dramatically increased, possibly up to 40,000 times. Since the sewage particles have this significantly increased surface area and are exposed to heated air they will dry rapidly. A heated air supply in the range of 580 to 620 degrees Celsius is suitable for this purpose, and can be expected to dry the incoming sewage within a matter of seconds.

Optionally the apparatus (17) can further include a classifier configured to further inhibit the progress of larger damper particles of product toward the product outlet (45), for example using a centrifugal separator.

The method of drying and milling the substantially dewatered product can be described as follows;
introduce the dewatered product into a chamber of the housing (41) slice or chop the dewatered product within the chamber,
introduce heated air into the chamber and expose the sliced or chopped product to the heated air immediately as it is sliced or chopped,
pass the sliced or chopped product directly into an attrition mill located within the same chamber, and
allow the finer or drier milled particles of the product to exit the chamber along with the airflow that is induced through the chamber.

Preferably at least 80 percent of the particles of product that exit the chamber are less than 0.08 millimetres in diameter, or the average size of the particles that exit the chamber is less than 0.5 millimetres in diameter. In any case it is the average size of the particles that exit the chamber should be less than 1.5 millimetres in diameter. The finer the particles the more efficiently they can be burned in the sterilisation chamber (13).

Preferably the moisture content of the particles that exit the chamber is between five and twelve percent by mass, or at least less than fifteen or twenty percent by mass.

The method of drying and milling substantially dewatered product described herein can form part of a product treatment process.

### Variations

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

While the milling and drying apparatus (17) has been described with reference to the drying of a product primarily in the form of sewage, it is envisaged that the apparatus will have uses in drying other products, for example waste products from food processing plants.

In the example shown the blades (55) of the second stage (63) are shown as flat blades. Alternative shapes for the blades (55) can be used, for example the blades (55) could take the form of pins or hammers.

### Definitions

Throughout this specification the word “comprise” and variations of that word, such as “comprises” and “comprising”, are not intended to exclude other additives, components, integers or steps.

### Advantages

Thus it can be seen that at least the preferred form of the invention provides a drying apparatus which can be used to significantly reduce the moisture content of sewage and to mill it in to relatively fine particles. Importantly the apparatus does not tend to clog, and performs reliably to a high standard. One of the reasons for this is that the sewage is sliced, chopped or macerated immediately before it is milled and no opportunity is provided for the sewage to reconstitute itself. Sewage has been found to be very sticky and reconstitution of the dewatered sewage was previously a significant problem.

Having overcome the problem of drying and milling sewage the apparatus and method of drying are suitable for use in larger sewage processing plants or processes.

1. A drying and milling apparatus having a housing and a rotatable section, the housing having an air or gas inlet and a product inlet at a first end and having a product outlet at a second end, the rotatable section having a plurality of blades which extend radially from a hub portion of the rotatable section and being adapted to rotate within the housing and to break up and to mill any product that is introduced into the housing, and the product inlet being configured to direct any incoming product directly onto the blades of the rotatable section.

2. A drying and milling apparatus as claimed in claim 1 wherein the product inlet is configured to direct any incoming product directly onto the tips of the blades.

3. A drying and milling apparatus as claimed in claim 2 wherein the rotatable section includes a first stage which is adapted to slice, chop or macerate any incoming product and a second stage which is adapted to finely mill the sliced, chopped or macerated product.

4. A drying and milling apparatus as claimed in claim 3 wherein the apparatus further includes stationary blades or vanes which project inwards generally from an outer diameter of the housing and which are situated between the paths of any rotating blades or vanes of the rotatable section.

5. A drying and milling apparatus as claimed in claim 4 wherein at least a portion of the blades of the first stage of the rotatable section are configured such that a width of each blade is generally aligned with the direction of rotation of the rotatable section.

6. A drying and milling apparatus as claimed in claim 5 wherein at least a portion of the blades of the second stage of the rotatable section are configured such that a width of each blade is generally aligned with the rotational axis of the rotatable section.

7. A drying and milling apparatus as claimed in claim 6 wherein the blades of the rotatable section are fixed relative to the hub portion of the rotatable section.

8. A drying and milling apparatus as claimed in claim 7 wherein the air or gas inlet is configured to introduce air or gas towards a first end of the rotatable section.

9. A drying and milling apparatus as claimed in claim 8 wherein the product outlet is situated adjacent to or about the rotational axis of the rotatable section.

10. A drying and milling apparatus as claimed in claim 9 wherein at least a portion of the housing is cylindrical in shape and the tips of the blades of the rotatable section are configured to travel adjacent to an internal diameter of the cylindrical shaped portion.

11. A drying and milling apparatus as claimed in claim 10 wherein at least a portion of the surface of the internal diameter of the housing is provided with grooves.

12. A drying and milling apparatus as claimed in claim 11 wherein the grooves are substantially helically aligned with respect to the rotational axis of the rotatable section.

13. A drying and milling apparatus as claimed in claim 12 wherein the second stage of the rotatable section in conjunction with the surface of the internal diameter of the housing forms an attrition mill.

14. A drying and milling apparatus as claimed in claim 13 wherein the apparatus can further include a classifier configured to inhibit the progress of larger damper particles of product toward the product outlet.

15. A drying and milling apparatus as claimed in claim 14 wherein the classifier includes a centrifugal separator.

16. (canceled)

17. A sewerage processing plant comprising a drying and milling apparatus as claimed in claim 1 wherein the plant further includes sewage sludge de-watering apparatus which is able to at least partially de-water sewage prior to the sewage entering the drying and milling apparatus.

18. A method of drying and milling substantially dewatered sewage including the steps of;
introducing the dewatered sewage into a chamber
slicing or chopping the dewatered sewage within the chamber,
introducing heated air into the chamber and exposing the sliced or chopped sewage to the heated air immediately as it is sliced or chopped,
passing the sliced or chopped sewage directly into an attrition mill located within the same chamber, and
allowing the finer or drier milled particles of the product to exit the chamber along with the airflow that is induced through the chamber.

19. A method of drying and milling substantially dewatered sewage as claimed in claim 18 wherein the airflow rate through the chamber is adjustable to allow a desired particle size or particle moisture content to be achieved.

20. A method of drying and milling substantially dewatered sewage as claimed in claim 19 wherein the rotational velocity of the mill is adjustable to allow a desired particle size or particle moisture content to be achieved.

21. A method of drying and milling substantially dewatered sewage as claimed in claim 20 wherein the average size of the particles that exit the chamber is less than 1.5 millimetres in diameter.

22. A method of drying and milling substantially dewatered sewage as claimed in claim 21 wherein the average size of the particles that exit the chamber is less than 0.5 millimetres in diameter.

23. A method of drying and milling substantially dewatered sewage as claimed in claim 22 wherein at least 80 percent of the particles that exit the chamber are less than 0.08 millimetres in diameter.

24. A method of drying and milling substantially dewatered sewage as claimed in claim 23 wherein the moisture content of the particles that exit the chamber is less than twenty percent by mass.

25. A method of drying and milling substantially dewatered sewage as claimed in claim 24 wherein the moisture content of the particles that exit the chamber is less than fifteen percent by mass.

26. A method of drying and milling substantially dewatered sewage as claimed in claim 25 wherein the moisture content of the particles that exit the chamber is between five and twelve percent by mass.

27.-31. (canceled)
